(19) United States
(12) Patent Application Publication
(10) Pub. No.: US 2006/0073856 A1
(43) Pub. Date: Apr. 6, 2006

(54) Remoted vibrating element for a mobile phone

(76) Inventor: Steven W. Lundberg, Edina, MN (US)

Correspondence Address: Schwegman, Lundberg, Woessner & Kluth, P.A., P.O. Box 2938, Minneapolis, MN, 55402, US

(21) Appl. No.: 11/223,694

(22) Filed: Sep. 9, 2005

Related U.S. Application Data
(60) Provisional application No. 60/608,291, filed on Sep. 9, 2004.

(51) Int. Cl. H04B 1/38

(52) U.S. Cl. 455/567; 455/556.2

(57) ABSTRACT

According to one example embodiment of the inventive subject matter, there is provided apparatus comprising a mobile telephone including a tactile ringer component that in a first mode is attached and carried with the mobile phone in a carrier mechanism and in a second mode is detached from the phone and carried in proximity to a user's body, and further wherein the vibrating ringer component is activated by a wireless signal from the mobile phone, generated by RF transmitter element. A receiver receives the signal. Receiver applies, in response to detection of an RF signal applies an RF detection signal to tactile activation circuit. Circuit, in turn, activates tactile element, such as a vibrating element or other tactile generator as described below. Phone electronics provide the operational circuitry and components to enable the operation and function of the mobile phone, as for example provided in commercially available mobile phones. RF activation of the tactile ringer may be provided for example by Blue Tooth™ technology.

### CROSS-REFERENCE TO RELATED APPLICATION

This application claims priority under 35 U.S.C. 119(e) of U.S. Provisional Application Ser. No.: 60/608,291, filed Sep. 9, 2004, which application is incorporated herein by reference.

### TECHNICAL FIELD

The present inventive subject matter relates to mobile telephone technology.

### BACKGROUND

Mobile telephone ringers are now ubiquitous and often annoying.

### BRIEF DESCRIPTION OF THE DRAWINGS

FIGS. 1 and 2 illustrate one example embodiment of the inventive subject matter.

### DETAILED DESCRIPTION

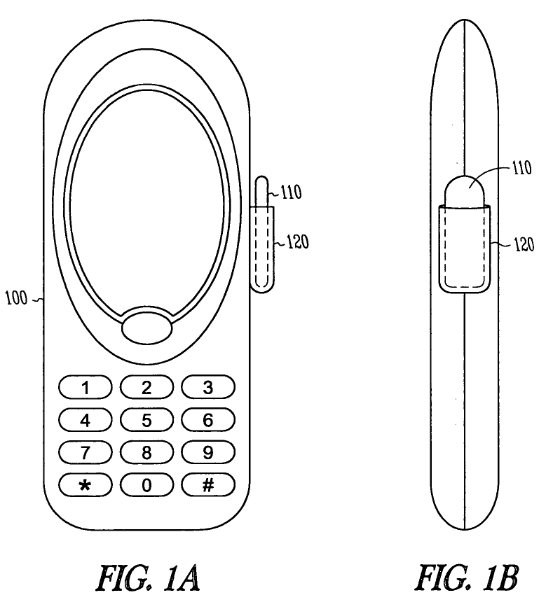

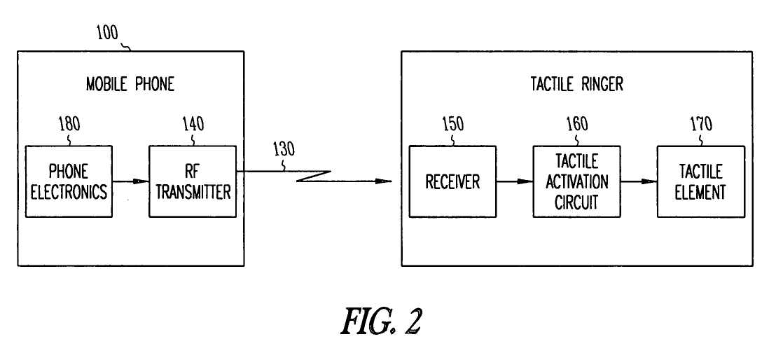

According to one example embodiment of the inventive subject matter, shown in FIGS. 1A, 1B, and 2, there is provided apparatus comprising a mobile telephone 100 including a tactile ringer component 110 that in a first mode is attached and carried with the mobile phone in a carrier mechanism 120 and in a second mode is detached from the phone and carried in proximity to a user's body, and further wherein the vibrating ringer component is activated by a wireless signal 130 from the mobile phone, generated by RF transmitter element 140. A receiver 150 receives the signal 130. Receiver 150 applies, in response to detection of an RF signal 130 applies an RF detection signal to tactile activation circuit 160. Circuit 160, in turn, activates tactile element 170, such as a vibrating element or other tactile generator as described below. Phone electronics 180 provide the operational circuitry and components to enable the operation and function of the mobile phone, as for example provided in commercially available mobile phones. RF activation of the tactile ringer may be provided for example by Blue Tooth™ technology.

According to one example embodiment of the inventive subject matter there is provided apparatus according to any combination of the embodiments, described herein above and below, wherein the component includes an elastic band that can be used to carry the component on a wrist or ankle.

According to one example embodiment of the inventive subject matter there is provided apparatus according to any combination of the embodiments, described herein above and below, wherein the component is sized to be carried in a pocket like a coin.

According to one example embodiment of the inventive subject matter there is provided apparatus according to any combination of the embodiments, described herein above and below, wherein the component includes a rechargable battery that charges when the component is attached to the mobile phone.

According to one example embodiment of the inventive subject matter there is provided apparatus according to any combination of the embodiments, described herein above and below, wherein the component is included in a wrist watch.

According to one example embodiment of the inventive subject matter there is provided apparatus according to any combination of the embodiments, described herein above and below, wherein the component is carried under a wrist watch on a user's wrist.

According to one example embodiment of the inventive subject matter there is provided apparatus according to any combination of the embodiments, described herein above and below, wherein the component includes elastic or other hook elements that can be thereaded through a watch band so as to support the component underneath a wrist watch while worn on a user.

According to one example embodiment of the inventive subject matter there is provided apparatus according to any combination of the embodiments, described herein above and below, wherein the component includes a vibrating element to provide tactile stimulation.

According to one example embodiment of the inventive subject matter there is provided apparatus according to any combination of the embodiments, described herein above and below, wherein the component includes an electrical stimulation circuit to provide a tingling sensation for tactile stimulation.

According to one example embodiment of the inventive subject matter there is provided apparatus according to any combination of the embodiments, described herein above and below, wherein the component is adapted to be worn inside a user's shoe.

According to one example embodiment of the inventive subject matter there is provided a method comprising carrying a tactile ringer component on a mobile telephone in a first mode of use and in a second mode of use detaching from the phone and carrying it in proximity to a user's body, and further wherein the vibrating ringer component is activated by a wireless signal from the mobile phone.

According to one example embodiment of the inventive subject matter there is provided a method according to any combination of the embodiments, described herein above and below, wherein the component includes an elastic band that can be used to carry the component on a wrist or ankle.

According to one example embodiment of the inventive subject matter there is provided a method according to any combination of the embodiments, described herein above and below, wherein the component is sized to be carried in a pocket like a coin.

According to one example embodiment of the inventive subject matter there is provided a method according to any combination of the embodiments, described herein above and below, wherein the component includes a rechargable battery that charges when the component is attached to the mobile phone.

According to one example embodiment of the inventive subject matter there is provided a method according to any combination of the embodiments, described herein above and below, wherein the component is included in a wrist watch.

According to one example embodiment of the inventive subject matter there is provided a method according to any combination of the embodiments, described herein above and below, wherein the component is carried under a wrist watch on a user's wrist.

According to one example embodiment of the inventive subject matter there is provided a method according to any combination of the embodiments, described herein above and below, wherein the component includes elastic or other hook elements that can be thereaded through a watch band so as to support the component underneath a wrist watch while worn on a user.

According to one example embodiment of the inventive subject matter there is provided a method According to one example embodiment of the inventive subject matter there is provided a method according to any combination of the embodiments, described herein above and below, wherein the component includes a vibrating element to provide tactile stimulation.

According to one example embodiment of the inventive subject matter there is provided a method according to any combination of the embodiments, described herein above and below, wherein the component includes an electrical stimulation circuit to provide a tingling sensation for tactile stimulation.

According to one example embodiment of the inventive subject matter there is provided a method according to any combination of the embodiments, described herein above and below, wherein the component is adapted to be worn inside a user's shoe.

1. Apparatus comprising a mobile telephone including a tactile ringer component that in a first mode is attached and carried with the mobile phone and in a second mode is detached from the phone and carried in proximity to a user's body, and further wherein the vibrating ringer component is activated by a wireless signal from the mobile phone.

2. The apparatus according to claim 1, wherein the component includes an elastic band that can be used to carry the component on a wrist or ankle.

3. The apparatus according to claim 1, wherein the component is sized to be carried in a pocket like a coin.

4. The apparatus according to claim 1, wherein the component includes a rechargable battery that charges when the component is attached to the mobile phone.

5. The apparatus according to claim 1, wherein the component is included in a wrist watch.

6. The apparatus according to claim 1, wherein the component is carried under a wrist watch on a user's wrist.

7. The apparatus according to claim 1, wherein the component includes elastic or other hook elements that can be threaded through a watch band so as to support the component underneath a wrist watch while worn on a user.

8. The apparatus according to claim 1, wherein the component includes a vibrating element to provide tactile stimulation.

9. The apparatus according to claim 1, wherein the component includes an electrical stimulation circuit to provide a tingling sensation for tactile stimulation.

10. The apparatus according to claim 1, wherein the component is adapted to be worn inside a user's shoe.

11. A method comprising carrying a tactile ringer component on a mobile telephone in a first mode of use and in a second mode of use detaching from the phone and carrying it in proximity to a user's body, and further wherein the vibrating ringer component is activated by a wireless signal from the mobile phone.

12. The method according to claim 11 wherein the component includes an elastic band that can be used to carry the component on a wrist or ankle.

13. The method according to claim 11 wherein the component is sized to be carried in a pocket like a coin.

14. The method according to claim 11 wherein the component includes a rechargable battery that charges when the component is attached to the mobile phone.

15. The method according to claim 11 wherein the component is included in a wrist watch.

16. The method according to claim 11 wherein the component is carried under a wrist watch on a user's wrist.

17. The method according to claim 11 wherein the component includes elastic or other hook elements that can be thereaded through a watch band so as to support the component underneath a wrist watch while worn on a user.

18. The method according to claim 11 wherein the component includes a vibrating element to provide tactile stimulation.

19. The method according to claim 11 wherein the component includes an electrical stimulation circuit to provide a tingling sensation for tactile stimulation.

20. The method according to claim 11 wherein the component is adapted to be worn inside a user's shoe.
